(19) United States
(12) Patent Application Publication
(10) Pub. No.: US 2016/0362086 A1
(43) Pub. Date: Dec. 15, 2016

(54) DRIVE DEVICE FOR A WINDSCREEN WIPING DEVICE

(71) Applicant: Robert Bosch GmbH, Stuttgart (DE)

(72) Inventors: Andreas Biank, Oberlauterbach (FR); Achim Kraus, Belgrade (RS); Ulrich Metz, Achern (DE); Swen Koehn, Eggenstein (DE); Danny Wengler, Karlsruhe (DE)

(21) Appl. No.: 15/120,794

(22) PCT Filed: Jan. 21, 2015
(86) PCT No.: PCT/EP2015/051121

§ 371 Date: Aug. 23, 2016

(30) Foreign Application Priority Data
Feb. 24, 2014 (DE) 10 2014 203 217.2

(51) Int. Cl. B60S 1/08; B60S 1/34; H02K 7/00; B60S 1/18

(52) U.S. Cl. CPC B60S 1/08; B60S 1/18; B60S 1/3495; H02K 7/003

(57) ABSTRACT

The invention relates to a drive device for a windscreen wiping device, comprising an electric drive motor and a transmission for driving an output shaft shaft, said output shaft supporting the first wiper arm and drives a transmission rod assembly which actuates a second wiper arm.

### BACKGROUND OF THE INVENTION

The invention relates to a drive device for a windscreen wiping device.

The German patent specification DE 102 61 926 A1 discloses a drive device for a windscreen wiping device in a motor vehicle, said windscreen wiping device comprising a drive unit which includes an electric drive motor and a downstream transmission, in which the rotational movement of the drive motor is converted into a rotating pendulum movement of an output shaft. The output shaft supports a first wiper arm which rests on the vehicle window pane to be cleaned. In addition, the output shaft drives a transmission rod assembly which sets a further shaft into a rotating pendulum movement, said further shaft supporting a second wiper arm that rests on a vehicle window pane. This embodiment has the advantage that only one drive unit comprising an electric drive motor is required to drive two wiper arms.

### SUMMARY OF THE INVENTION

The aim underlying the present invention is to design a drive device for a windscreen wiping device, which comprises an electric drive motor and a transmission, a first wiper arm as well as a transmission rod assembly that includes a second wiper arm, using simple constructive measures such that both wiper arms can be reliably actuated over a long operating period.

The drive device according to the invention is used for a windscreen wiping device in a vehicle, for example for windscreen wipers for cleaning the windscreen, and comprises a drive unit that includes an electric drive motor and a downstream transmission which converts the rotational movement of the drive motor into a rotating pendulum movement of an output shaft. The output shaft supports a first wiper arm, the wiper blade of which rests on the vehicle window pane to be cleaned. A component of a transmission rod assembly, which sets a further shaft into a rotating pendulum movement, furthermore engages on the output shaft, wherein the further shaft supports a second wiper arm comprising a wiper blade that rests on the vehicle window pane. The output shaft, which is directly driven via the transmission by the drive motor, thus drives the second shaft comprising the second wiper arm via the transmission rod assembly.

The first wiper arm is coupled in a rotationally fixed manner to the output shaft via a first connection point. A component of the transmission rod assembly engages on the output shaft at a second connection point which is spaced apart axially from said first connection point, said component likewise being coupled in a rotationally fixed manner to the output shaft. Said component, for example a crank, executes accordingly the same rotating pendulum movement as the output shaft, which rotating pendulum movement is converted via further components of the transmission rod assembly into the desired rotating pendulum movement of the second shaft which supports the second wiper arm. The second wiper arm can in this case either carry out a wiping movement parallel to the first wiper arm or a wiping movement that is in the opposite direction to said first wiper arm.

The first and the second connection point are fundamentally constructed in the same way and ensure in each case a rotationally fixed coupling of the first wiper arm or, respectively, the component of the transmission rod assembly to the output shaft. This coupling is ensured by means of a connection section per connection point on the output shaft. A hub of the first wiper arm or, respectively, the component of the transmission rod assembly is mounted on the connection section in a force-fit or form-fit manner. During assembly, the component of the transmission rod assembly is, for example, pushed axially with a hub-shaped recess thereof onto the output shaft until reaching the associated connection section. The wiper arm is subsequently mounted with a hub-shaped recess thereof onto the associated connection section on the output shaft.

The force-fit or form-fit connection is achieved by mounting the component of the transmission rod assembly or, respectively, the wiper arm onto the respectively associated connection section, said connection being achieved, for example, by the relevant connection section on the output shaft having a roughened up or irregular surface. The hub of the component of the transmission rod assembly or, respectively, of the wiper arm can be axially pushed onto the connection point in the manner of a press fit, whereby the desired rotationally fixed coupling is achieved in the circumferential direction or, respectively, direction of rotation. This coupling can be achieved either by means of a force-fit and/or a form-fit connection between the connection partners.

The connection points on the output shaft are preferably constructed in the same manner, whereby a uniformity and standardization of the connections is achieved. It can, for example, be useful to design each of the connection sections on the output shaft as a knurled section having a knurled surface. The knurled section has, for example, a ribbing parallel to the longitudinal axis of the output shaft, which supports the rotationally fixed coupling to the wiper arm or, respectively, to the component of the transmission rod assembly. Other corrugated patterns are however also possible, for example a cross-ribbing. The hub-shaped recess in the wiper arm or, respectively, in the component of the transmission rod assembly can likewise be provided with a ribbing or knurling in order to support the production of a rotationally fixed coupling.

In the case of a force-fit connection in the region of the two connection points, the surfaces on the lateral surface of the output shaft in the region of the connection section as well as on the inside of the hub-like recess on the wiper arm or, respectively, on the component of the transmission rod assembly are advantageously designed in a rotationally symmetrical manner. A form-fit connection is, however, also possible in which the respective surfaces are designed in a non-rotationally symmetrical manner, for example as a polygon. In addition, a combination of a force-fit and a form-fit connection is possible by the surfaces being designed in a non-rotationally symmetrical manner and at the same time having a roughened up surface in the form of a ribbing or knurling.

The connection sections can, for example, be designed conically or cylindrically. In so doing, it is possible for both connection sections on the output shaft to be of conical design or to be of cylindrical design. An embodiment may also be considered which comprises a conical connection section and a cylindrical connection section, for example a conical embodiment for the coupling between the output shaft and the first wiper arm adjacent to the end face of the output shaft and a cylindrical embodiment for the coupling between the output shaft and the component of the transmission rod assembly.

According to a further advantageous embodiment of the invention, the output shaft has a different diameter on the two sections thereof which axially delimit the connection section from the transmission rod assembly. These output shaft sections are each of cylindrical design. The component of the transmission rod assembly, which is pushed by means of the hub-like recess thereof onto the output shaft until reaching the associated connection section, is preferably placed over the output drive shaft section having the smaller diameter, wherein the oppositely lying output shaft section having the larger diameter forms a stop for delimiting the axial mounting of said component of the transmission rod assembly.

It can furthermore be advantageous to apply a thread for receiving a nut onto the output shaft adjacent to the connection section for the transmission rod assembly. The nut screwed onto the output shaft secures the component of the transmission rod assembly in the axial position thereof on said output shaft. Such an axial securing of said component is, however, also possible, for example, by producing an axial stop on the output shaft, which, for example, is produced by deformation by means of wobble riveting. In addition, a reduction in the diameter of the component of the transmission rod assembly which engages around the output shaft is possible by means of ring caulking in order to axially secure the component on the output shaft.

### BRIEF DESCRIPTION OF THE DRAWINGS

Further advantages and useful embodiments of the invention can be extracted from the further claims, the description of the figures and the drawings. In the drawings:

FIG. 1 shows a schematic depiction of a windscreen wiping device for a vehicle, having a drive device, which includes a drive unit comprising an electric drive motor and a transmission for driving an output shaft, on which a first wiper arm is mounted, as well as having a transmission rod assembly for driving a second wiper arm;

FIG. 2 shows the drive device comprising the output shaft, which, in the region of the free end face thereof, has a first, conical connection section and a second conical connection section axially spaced apart therefrom;

FIG. 3 shows a depiction of the drive device corresponding to FIG. 2, wherein the second connection section is of cylindrical design;

FIG. 4 shows the drive device in a further embodiment variant, in which a circumferential shoulder which forms a stop is produced on the lateral surface of the output shaft by means of wobble riveting; and

FIG. 5 shows a drive device in a further embodiment variant, in which the transmission component mounted on the second connection section is connected to the output shaft in the axial and circumferential direction by means of ring caulking.

In the figures, identical components are provided with the same reference signs.

### DETAILED DESCRIPTION

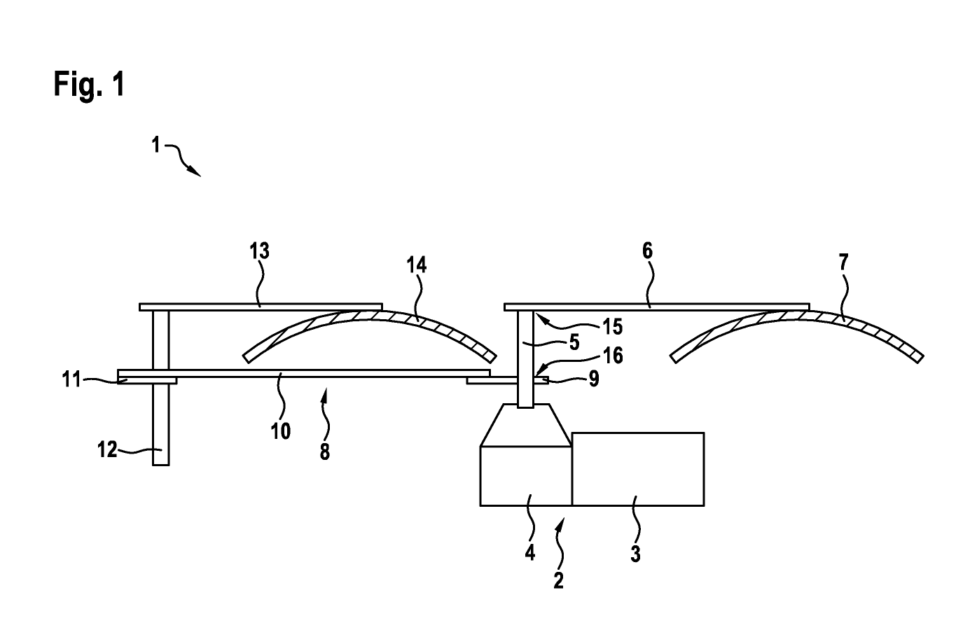

A windscreen wiping device 1 for a motor vehicle is depicted in FIG. 1, with which, for example, the windscreen of the vehicle can be cleaned. The windscreen wiping device 1 includes a drive device 2 comprising a drive unit, which consists of an electric drive motor 3 and a downstream transmission 4, in which the rotatory drive movement of the drive motor 3 is converted into a rotating pendulum movement of an output shaft 5 which is directly driven by the transmission 4. A first wiper arm 6, which supports a wiper blade 7 that rests on the vehicle window pane, is mounted on the output shaft 5 at a connection point 15 in the region of the free end face.

A second connection point 16 is disposed on the output shaft between the transmission 4 and the first wiper arm 6 so as to be axially spaced apart from the connection 15. A transmission rod assembly 8 is driven via the second connection point 16, said transmission rod assembly being coupled to a further shaft 12, which supports a second wiper arm 13 comprising a wiper blade 14 that likewise rests on the vehicle window pane. The transmission rod assembly 8 comprises a crank 9, a crank arm 10 as well as a rocker arm 11, wherein the crank 9 is connected to the output shaft 5 in a rotationally fixed manner and the rocker arm 11 is connected to the further shaft 12 in a rotationally fixed manner, on which shaft 12 the second wiper arm 13 is mounted. The intermediate crank arm 10 is coupled to the crank 9 as well as to the rocker arm 11 in an articulated manner.

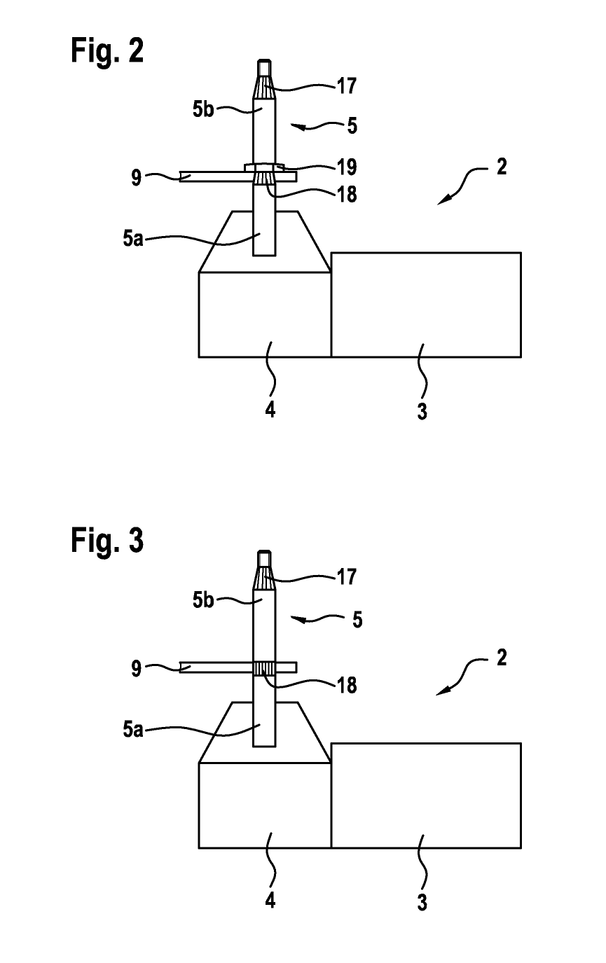

In FIGS. 2 to 5, the connection sections 17 and 18 on the output shaft 5, which are a constituent part of the connection points to the wiper arm or, respectively, to the transmission rod assembly comprising the crank 9, are depicted in detail in different embodiment variants. According to FIG. 2, both connection sections 17 and 18 are conically configured adjacent to the free end face or, respectively, spaced apart axially from the end face and are provided with a ribbing or, respectively, knurling, which has a multiplicity of rib-shaped notches distributed over the periphery of said connection sections. A hub-shaped recess of the first wiper arm 6 or, respectively, the crank 9 is in each case mounted on the conical connection sections 17 and 18, wherein the wiper arm and the crank are connected in a rotationally fixed manner to the output shaft 5. Hence, this relates to a basically uniform connection between the output shaft in the region of the connection sections 17, 18 to the first wiper arm or, respectively, to the component of the transmission rod assembly.

The further exemplary embodiments according to FIGS. 3 to 5 also have uniform connection sections 17 and 18 for connecting to the first wiper arm or, respectively, to the transmission rod assembly. The connection section 17, 18 is in each case provided with a ribbing or knurling for an improved rotationally fixed coupling to the wiper arm or, respectively, to the component of the transmission rod assembly.

As can further be extracted from FIG. 2, a nut 19 is mounted on the output shaft 5, which is screwed onto an external thread, which is introduced into the lateral surface of the output shaft 5 directly axially adjacent to the second connection section 18. The two output shaft sections 5a and 5b, which adjoin the second conical connection sections 18 on different sides, have diameters that vary in size, wherein the output shaft section 5b adjacent to the free end face has a smaller diameter than the output shaft section 5a. Hence, the conical second connection section 18 on the side facing the output shaft section 5a has a larger diameter than on the side facing the output shaft section 5b.

In the further exemplary embodiments according to FIGS. 3 to 5, the output shaft 5 has two cylindrical output shaft sections 5a, 5b having diameters that vary in size, of which the output shaft section 5a on the side facing away from the free end face has the larger diameter. According to FIG. 3, the first connection section 17 on the end face side is conical in design, and the second connection section 18 axially spaced apart from said first connection section is cylindrical in design. Due to the larger diameter of the output shaft section 5a, the transition between the connection section 18 and the output shaft section 5a forms a radially enlarged ring shoulder, which forms a stop for the crank 9. The crank 9 can thus be pushed over the free end face of the output shaft 5 until reaching the second connection section 18 and the ring shoulder at the transition of the second connection section 18 to the output shaft section 5a.

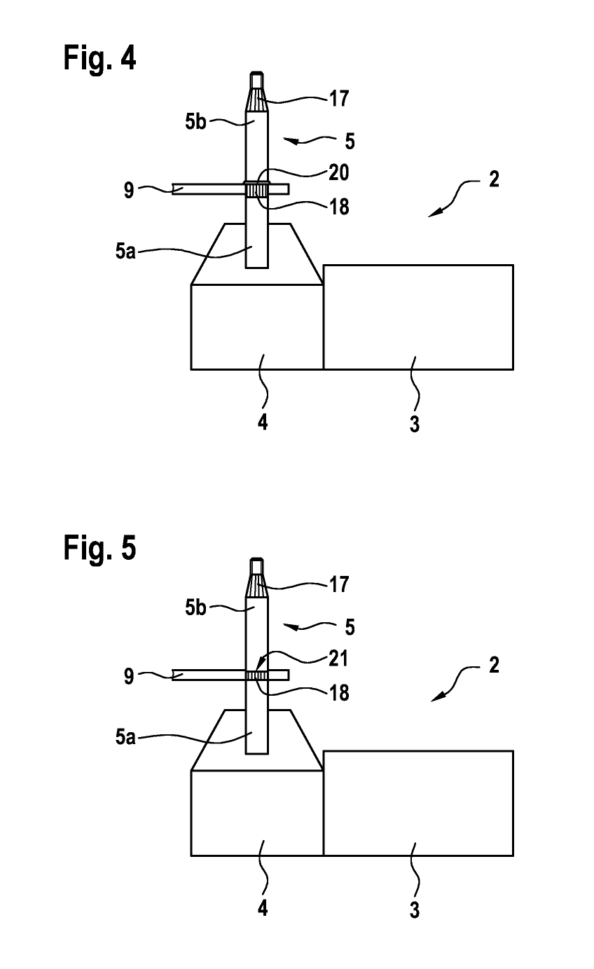

In FIGS. 4 and 5, the output shaft 5 also has a conical first connection section 17 and a cylindrical second connection section 18. According to FIG. 4, the output shaft 5 is deformed on the upper side of the second connection section 18 in the region of the lateral surface thereof, whereby a radially slightly enlarged stop 20 results, which secures the crank 9 axially in the position thereof. The deformation is, for example, is produced by means of wobble riveting. The crank 9 is thus held axially downwards by means of the larger diameter of the output shaft section 5a and axially upwards by means of the deformed stop 20 in the axial position thereof.

In FIG. 5, the crank 9 is deformed in the region of the hub-shaped recess by means of ring caulking on the upper axial edge, as denoted with the reference sign 21, whereby an axial fixing of the crank 9 results axially upwards. If need be, the edge on the crank 9 which lies axially at the bottom can also be ring caulked.

1. A drive device for a windscreen wiping device (1), the drive device comprising a drive unit which includes an electric drive motor (3) and a transmission (4), an output shaft (5) which supports a first wiper arm (6), and a transmission rod assembly (8) for driving a second wiper arm (13), wherein a first connection point (15) and a second connection point (15, 16) to the first wiper arm (6) and the transmission rod assembly, respectively, are disposed axially spaced apart from one another on the output shaft (5), characterized in that the first and second connection points (15, 16) are shaft-hub connections, wherein first and second connection sections (17, 18), on which a hub of the first wiper arm (6) and a hub of a component of the transmission rod assembly (8) are respectively mounted in a force-fit or form-fit manner, are disposed in each case on the output shaft (5) in the region of the connection points (15, 16).

2. The drive device according to claim 1, characterized in that the connection sections (17, 18) on the output shaft (5) are each a knurled section.

3. The drive device according to claim 1, characterized in that the first connection section (17) to the first wiper arm is conical.

4. The drive device according to claim 1, characterized in that the second connection section (18) to the transmission rod assembly (8) is conical.

5. The drive device according to claim 1, characterized in that the second connection section (18) to the transmission rod assembly (8) is cylindrical.

6. The drive device according to claim 1, characterized in that the second connection section (18) to the transmission rod assembly (8) is disposed between two cylindrical output shaft sections (5a, 5b) having different diameters.

7. The drive device according to claim 1, characterized in that a thread for receiving a nut (19) is applied to the output shaft (5) adjacent to the second connection section (18) to the transmission rod assembly (8).

8. The drive device according to claim 1, characterized in that an axial stop produced by deformation, is introduced into the output shaft (5) axially adjacent to a connection section (17, 18).

9. The drive device according to claim 1, characterized in that a component of the transmission rod assembly (8) is axially secured on the second connection section (18) by ring caulking.

10. A windscreen wiping device in a vehicle, comprising a drive device (2) according to claim 1.

11. The windscreen wiping device according to claim 10, characterized in that the connection sections (17, 18) on the output shaft (5) are each a knurled section.

12. The windscreen wiping device according to claim 10, characterized in that the first connection section (17) to the first wiper arm is conical.

13. The windscreen wiping device according to claim 10, characterized in that the second connection section (18) to the transmission rod assembly (8) is conical.

14. The windscreen wiping device according to claim 10, characterized in that the second connection section (18) to the transmission rod assembly (8) is cylindrical.

15. The windscreen wiping device according to claim 10, characterized in that the second connection section (18) to the transmission rod assembly (8) is disposed between two cylindrical output shaft sections (5a, 5b) having different diameters.

16. The windscreen wiping device according to claim 10, characterized in that a thread for receiving a nut (19) is applied to the output shaft (5) adjacent to the second connection section (18) to the transmission rod assembly (8).

17. The windscreen wiping device according to claim 10, characterized in that an axial stop produced by deformation is introduced into the output shaft (5) axially adjacent to a connection section (17, 18).

18. The windscreen wiping device according to claim 10, characterized in that a component of the transmission rod assembly (8) is axially secured on the second connection section (18) by ring caulking.

19. The windscreen wiping device according to claim 10, characterized in that an axial stop produced by wobble riveting is introduced into the output shaft (5) axially adjacent to a connection section (17, 18).

20. The drive device according to claim 1, characterized in that an axial stop produced by wobble riveting is introduced into the output shaft (5) axially adjacent to a connection section (17, 18).
